(19) United States
(12) Patent Application Publication
(10) Pub. No.: US 2025/0392981 A1
(43) Pub. Date: Dec. 25, 2025

(54) DYNAMIC RETRIEVAL AND MANAGEMENT OF NETWORK FUNCTION INFORMATION

(71) Applicant: T-Mobile USA, Inc., Bellevue, WA (US)

(72) Inventors: Maria Victoria Cabamalan, Covington, WA (US); Salvador C. Mendoza, Issaquah, WA (US)

(21) Appl. No.: 18/753,065

(22) Filed: Jun. 25, 2024

(51) Int. Cl. H04W 48/16; H04W 24/02; H04W 60/04

(52) U.S. Cl. CPC H04W 48/16; H04W 24/02; H04W 60/04

(57) ABSTRACT

Methods, devices, and systems related to dynamic maintenance and management of Network Function information are disclosed. In one example aspect, a method for wireless communication includes transmitting, by a network node, a discovery message to a Network Repository Function (NRF) node, maintaining, by the network node, a local storage storing a subset of the information carried in the search result, determining, in response to the NRF node encountering an outage, information about a first network function node of the one or more network function nodes using the local storage, and performing, by the network node, a communication with the first network function while the NRF node being in the outage.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency, are also important to meeting the needs of various communication scenarios.

### BRIEF DESCRIPTION OF THE DRAWINGS

Detailed descriptions of implementations of the present invention will be described and explained through the use of the accompanying drawings.

FIG. 1 is a block diagram that illustrates a wireless communications system that can implement aspects of the present technology.

FIG. 2 is a block diagram that illustrates 5G core network functions (NFs) that can implement aspects of the present technology.

FIG. 3 illustrates an example NF registration procedure to NF Repository Function (NRF).

FIG. 4 illustrates an example NF discovery procedure to NRF in accordance with one or more embodiments of the present technology.

FIG. 5 illustrates an example NF list retrieval procedure to NRF in accordance with one or more embodiments of the present technology.

FIG. 6 is a flowchart representation of a method for wireless communication in accordance with one or more embodiments of the present technology.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Network Functions (NFs) in the core network provide various services to provide communication to the User Equipment (UE) via the access network. When an NF is put into service, it registers its own services that other NFs can use with the NF Repository Function (NRF). When an NF is taken offline, it sends a deregistration message to the NRF to take it off the active NF list serving that NF’s service. When an outage occurs at the NRF, however, only a static back-up list of other NFs is available, leading to communication delay and disturbance. This patent document discloses techniques that can be implemented in various embodiments to allow NFs to dynamically query the NRF to obtain and store the most recent information of NFs. Having the NFs to dynamically store and update information about NFs can solve the problem of outdated static NF list that is maintained manually during NRF outages.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

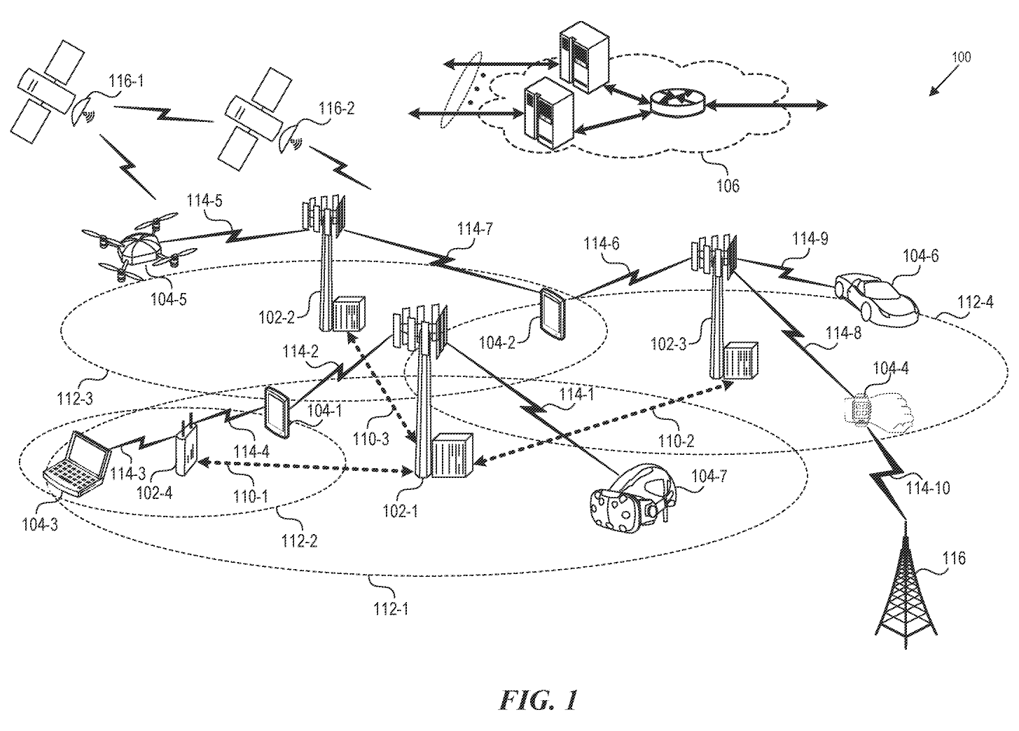

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, internet protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The coverage area 112 for a base station 102 can be divided into sectors making up only a portion of the coverage area (not shown). The network 100 can include base stations of different types (e.g., macro and/or small cell base stations). In some implementations, there can be overlapping coverage areas 112 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term “eNBs” is used to describe the base stations 102, and in 5G new radio (NR) networks, the term “gNBs” is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (AR/VR) connectivity 104-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 104) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102 and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites, such as satellites 116-1 and 116-2, to deliver services anywhere and anytime and provide coverage in areas that are unreachable by any conventional Terrestrial Network (TN). A 6G implementation of the network 100 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low user plane latency. In yet another example of 6G, the network 100 can implement a converged Wi-Fi and Core architecture to increase and improve indoor coverage.

### 5G Core Network Functions

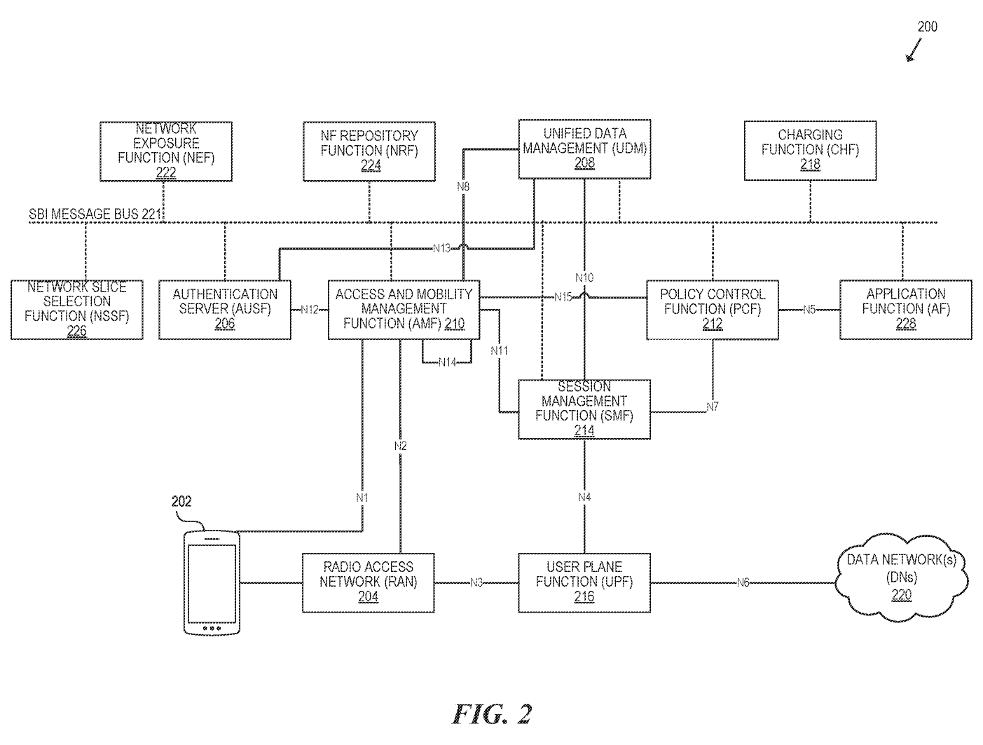

FIG. 2 is a block diagram that illustrates an architecture 200 including 5G core NFs that can implement aspects of the present technology. A wireless device 202 can access the 5G network through a NAN (e.g., gNB) of a RAN 204. The NFs include an Authentication Server Function (AUSF) 206, a Unified Data Management (UDM) 208, an Access and Mobility management Function (AMF) 210, a Policy Control Function (PCF) 212, a Session Management Function (SMF) 214, a User Plane Function (UPF) 216, and a Charging Function (CHF) 218.

The interfaces N1 through N15 define communications and/or protocols between each NF as described in relevant standards. The UPF 216 is part of the user plane and the AMF 210, SMF 214, PCF 212, AUSF 206, and UDM 208 are part of the control plane. One or more UPFs can connect with one or more data networks (DNs) 220. The UPF 216 can be deployed separately from control plane functions. The NFs of the control plane are modularized such that they can be scaled independently. As shown, each NF service exposes its functionality in a Service Based Architecture (SBA) through a Service Based Interface (SBI) 221 that uses HTTP/2. The SBA can include a Network Exposure Function (NEF) 222, an NF Repository Function (NRF) 224, a Network Slice Selection Function (NSSF) 226, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 224, which maintains a record of available NF instances and supported services. The NRF 224 allows other NF instances to subscribe and be notified of registrations from NF instances of a given type. The NRF 224 supports service discovery by receipt of discovery requests from NF instances and, in response, details which NF instances support specific services.

The NSSF 226 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 202 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 208 and then requests an appropriate network slice of the NSSF 226.

The UDM 208 introduces a User Data Convergence (UDC) that separates a User Data Repository (UDR) for storing and managing subscriber information. As such, the UDM 208 can employ the UDC under 3GPP TS 22.101 to support a layered architecture that separates user data from application logic. The UDM 208 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 208 can contain voluminous amounts of data that is accessed for authentication. Thus, the UDM 208 is analogous to a Home Subscriber Server (HSS) and can provide authentication credentials while being employed by the AMF 210 and SMF 214 to retrieve subscriber data and context.

The PCF 212 can connect with one or more Application Functions (AFs) 228. The PCF 212 supports a unified policy framework within the 5G infrastructure for governing network behavior. The PCF 212 accesses the subscription information required to make policy decisions from the UDM 208 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 224. This allows the SCP to become the delegated discovery point in a datacenter, offloading the NRF 224 from distributed service meshes that make up a network operator’s infrastructure. Together with the NRF 224, the SCP forms the hierarchical 5G service mesh.

The AMF 210 receives requests and handles connection and mobility management while forwarding session management requirements over the N11 interface to the SMF 214. The AMF 210 determines that the SMF 214 is best suited to handle the connection request by querying the NRF 224. That interface and the N11 interface between the AMF 210 and the SMF 214 assigned by the NRF 224 use the SBI 221. During session establishment or modification, the SMF 214 also interacts with the PCF 212 over the N7 interface and the subscriber profile information stored within the UDM 208. Employing the SBI 221, the PCF 212 provides the foundation of the policy framework that, along with the more typical QoS and charging rules, includes network slice selection, which is regulated by the NSSF 226.

### Dynamic Retrieval and Management of Information from NRF

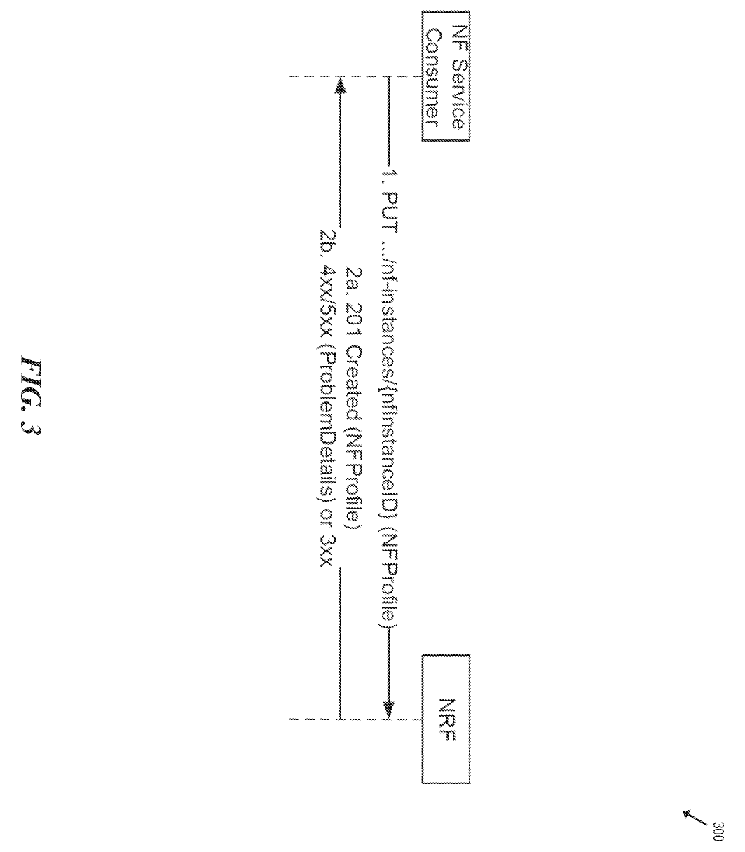

The NFs in the core network avail each other’s services and communicate with each other via network protocol(s) (e.g., HTTP2) over the IP network. Through the life cycle of an NF, it can be put into or removed from operation due to maintenance activities or operational issues. The NF’s availability for service is registered and discovered by NFs themselves via the NRF. When an NF is put into service, it is configured with an NRF IP endpoint where it registers its own services that other NFs can use. FIG. 3 illustrates an example NF registration procedure to NRF. When an NF is taken offline, it sends a deregistration message to the NRF to take it off the active NF list serving that NF’s service. This process provides an automated way of maintaining a dynamic database of thousands of NFs that are available online. During an NRF outage, or in cases where the NRF responses are delayed as if the NRF is unreachable, however, the NFs rely on a backup list of other NFs that is maintained statically within its own system. This static list is configured manually on every NF. But since the NFs go online and offline dynamically, the static list is not a very reliable source, as it can be outdated in a matter of days. Today, operators rely on scripts to check the validity of static NF entries to determine whether NFs in the static list are active in the NRF database. In some implementations, an auditing process that cross-references different static NF entries is used to remove the stale information. However, this process requires manual effort and cannot ensure dynamic update of the information when outages occur. For example, an AMF selects an SMF based on the information provided by the UE and other network policies. The available SMF(s) can change dynamically through registration/deregistration with the NRF. When the NRF experiences an outage, the AMF may not be able to identify the most recent/appropriate SMF based on static or stale information.

This patent document discloses techniques that can be implemented in various embodiments to allow NFs to store a valid NF list based on received information from the NRF. Having the NFs dynamically store an NF list can solve the problem of an outdated static NF list that is maintained manually during NRF outages. The embodiments described below can be implemented or combined with each other. Furthermore, some embodiments are described with reference to Third Generation Partnership Project (3GPP) Fifth Generation (5G) New Radio (NR) or Sixth Generation (6G) standard for ease of understanding, and the described technology may be implemented in different wireless systems that implement protocols other than the NR or 6G protocol.

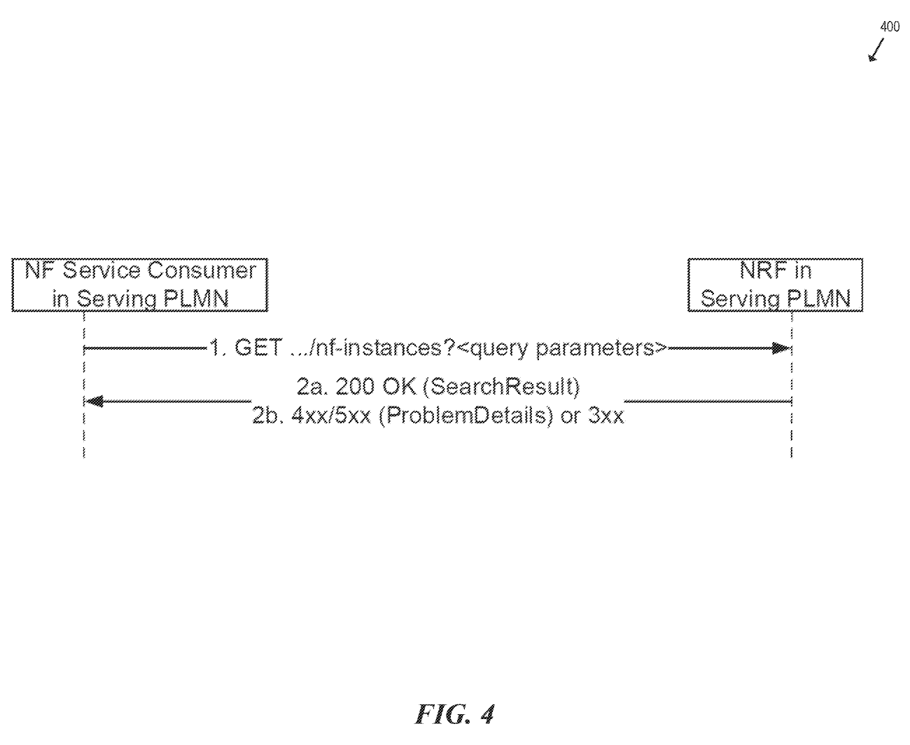

In some embodiments, the NF can leverage the NF discovery procedure to locally store the responses received from the NRF (e.g., in a cache or other types of local memory/databases). The Nnrf_NFDiscovery service allows an NF or SCP Instance to discover other NF instances with the potential services they offer, or to discover SEPP instances in the same PLMN, by querying the local NRF. FIG. 4 illustrates an example NF discovery procedure to NRF in accordance with one or more embodiments of the present technology. The NF Service Consumer sends an HTTP GET request to the resource Uniform Resource Identifier (URI) “nf-instances” collection resource. The input filter criteria for the discovery request are also included in query parameters. On success, the response includes a validity period, during which the search result can be considered as valid by the NF Service Consumer, and an array of NF profile objects and/or a map of NFInstanceInfo objects of NF instances that satisfy the search filter criteria (e.g., all NF instances offering a certain NF Service name in REGISTERED status or empty array in case search filter criteria do not match an NF instance in REGISTERED status).

The NF can compare the response against its local storage to determine whether the response needs to be added to the local storage or to override an existing entry in the local storage. The NF can also prune/remove stale entries based on the validity period associated with the prior stored records to ensure that the local storage keeps valid and up-to-date information. In some embodiments, the NF can scan the stored entries and remove those that have expired based on the indicated validity period. Upon the removal of stale entries, the NF can initiate another request to the NRF to get the most recent information to replace the pruned stale entries.

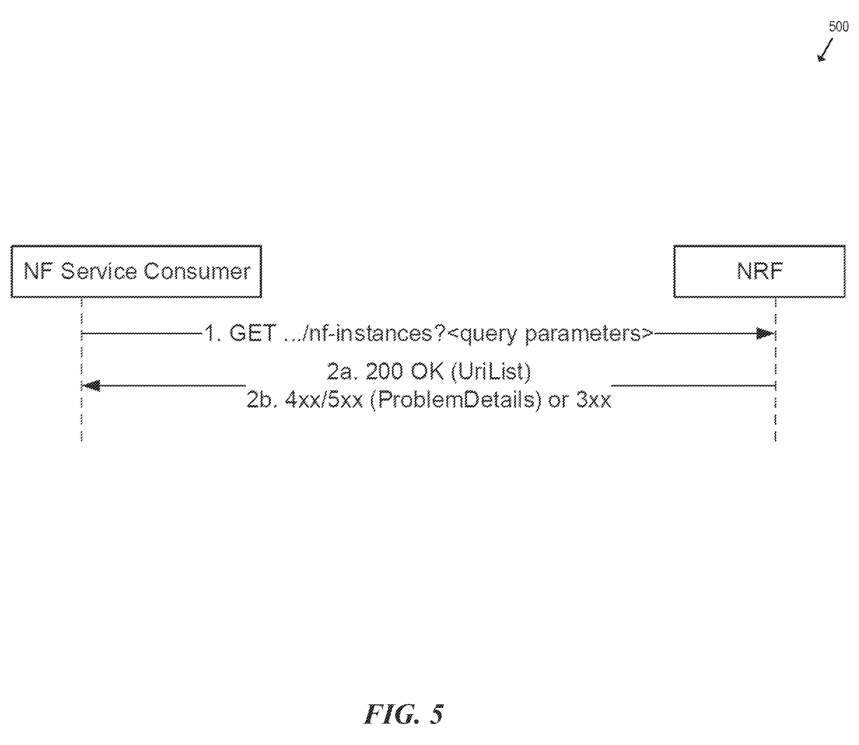

In some embodiments, the NFListRetrieval service operation is used, in addition to or in combination with the NF discovery operation, to obtain up-to-date information of the network functions. FIG. 5 illustrates an example NF list retrieval procedure to NRF in accordance with one or more embodiments of the present technology. The NFListRetrieval service operation allows the retrieval of a list of NF instances that are currently registered in NRF. The operation can apply to the whole set of registered NF instances or only to a subset of the NF instances based on a given NF type and/or maximum number of NF instances to be returned. The NF Service Consumer sends a request to the resource URI “nf-instances” collection resource. The optional input filter criteria (e.g., “nf-type”) and parameters for the retrieval request can be included in query parameters. On success, the response includes the URI of each registered NF in the NRF that satisfies the retrieval filter criteria (e.g., all NF instances of the same NF type) or an empty list if there are no NFs to return in the query result (e.g., because there are no registered NFs in the NRF, or because there are no matching NFs of the type specified in the “nf-type” query parameter, currently registered in the NRF).

In some embodiments, the NF can query and retrieve NF profile objects periodically as an alternative or in addition to the validity period check of the NF profile records. For example, one of the storage settings can be a periodicity to retrieve the most recent information from the NRF. As another example, the storage settings can also include a setting to trigger the retrieval of the most recent information based on one or more events/conditions. The storage settings are configurable so that the network operators can adjust the periodicity to achieve the desired balance with signaling overhead and robustness of the stored data.

Furthermore, the Service-Based Architecture (SBA) interfaces allow one or more separate servers to be set up as NF Service Consumers to centrally manage and store the query results for all registered NFs or a subset of the registered NFs. In some embodiments, each of the one or more separate servers provides a redundant copy of at least a subset of the NF profile objects. The redundancy can be used to improve data robustness so that, when the NRF fails, the remaining NF nodes can continue to operate with minimal impact to customer experiences.

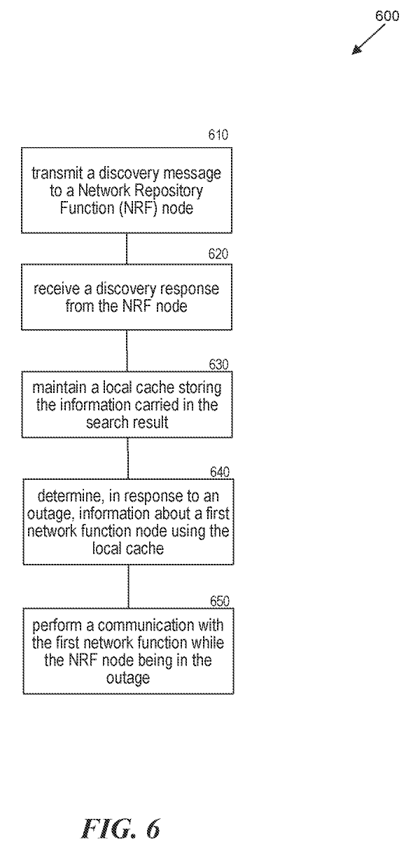

FIG. 6 is a flowchart representation of a method for wireless communication in accordance with one or more embodiments of the present technology. The method 600 includes, at operation 610, transmitting, by a network node, a discovery message to a Network Repository Function (NRF) node. The discovery message comprises one or more query parameters to discover one or more network function nodes. The method 600 includes, at operation 620, receiving, by the network node, a discovery response from the NRF node. The discovery response comprises a search result in response to the one or more query parameters, and the search result includes information about the one or more network function nodes. The method 600 includes, at operation 630, maintaining, by the network node, a local storage storing a subset of the information carried in the search result. The method 600 includes, at operation 640, determining, in response to the NRF node encountering an outage, information about a first network function node of the one or more network function nodes using the local storage. The method 600 also includes, at operation 650, performing, by the network node, a communication with the first network function while the NRF node is in the outage.

In some embodiments, the search result is associated with a validity period, and the maintaining of the local storage includes determining, by the network node, that the information about the one or more network function nodes in the search results has expired based on the validity period and removing, by the network node, the expired information about the one or more network function nodes from the local storage. The maintaining of the local storage can further include transmitting, by the network node, a request to the NRF node to obtain valid information about the one or more network functions and storing, by the network node, the valid information about the one or more network functions in the local storage. In some embodiments, the maintaining of the local storage comprises periodically transmitting, by the network node, a request to the NRF node to obtain updated information about the one or more network functions and storing, by the network node, the updated information about the one or more network functions. In some embodiments, a periodicity for the periodic transmitting of the request is configurable. The request can be the NFListRetrieval operation.

In some embodiments, the network node is a network function node (e.g., AMF/SMF). In some embodiments, the network node is a network server separate from network function nodes in a core network.

### Computer System

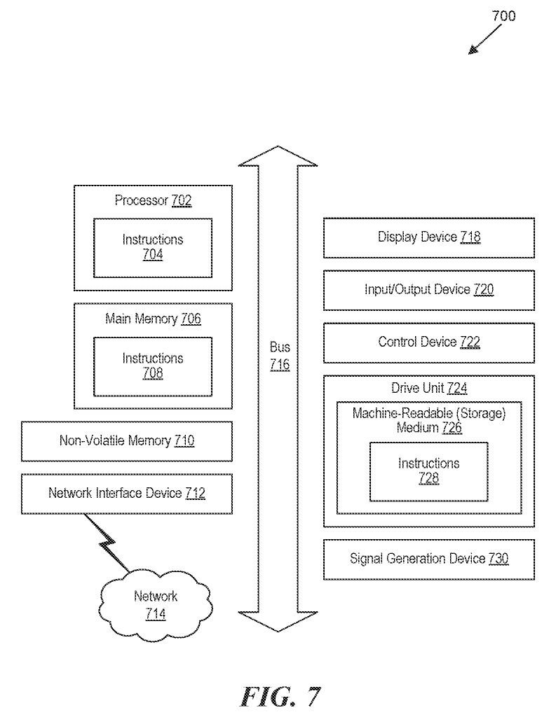

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A method for wireless communication, comprising:
transmitting, by a network node, a discovery message to a Network Repository Function (NRF) node,
wherein the discovery message comprises one or more query parameters to discover one or more network function nodes;
receiving, by the network node, a discovery response from the NRF node,
wherein the discovery response comprises a search result in response to the one or more query parameters, the search result comprising information of the one or more network function nodes;
maintaining, by the network node, a local storage storing a subset of the information carried in the search result;
determining, in response to the NRF node encountering an outage, information about a first network function node of the one or more network function nodes using the local storage; and
performing, by the network node, a communication with the first network function node while the NRF node being in the outage.

2. The method of claim 1, wherein the search result is associated with a validity period, and wherein the maintaining of the local storage comprises:
determining, by the network node, that the information about the one or more network function nodes in the search result has expired based on the validity period; and
removing, by the network node, the expired information about the one or more network function nodes from the local storage.

3. The method of claim 2, wherein the maintaining of the local storage further comprises:
transmitting, by the network node, a request to the NRF node to obtain valid information about the one or more network function nodes; and
storing, by the network node, the valid information about the one or more network function nodes in the local storage.

4. The method of claim 1, wherein the maintaining of the local storage comprises:
periodically transmitting, by the network node, a request to the NRF node to obtain updated information about the one or more network function nodes;
storing, by the network node, the updated information about the one or more network function nodes.

5. The method of claim 4, wherein a periodicity for the periodically transmitting of the request is configurable.

6. The method of claim 1, wherein the network node is a network function node.

7. The method of claim 1, wherein the network node comprises an Access and Mobility Management Function (AMF) and the first network function node comprises a Session Management Function (SMF).

8. The method of claim 1, wherein the network node is a network server separate from network function nodes in a core network.

9. The method of claim 8, comprising:
providing, by the network server upon the outage of the NRF node, the information of the one or more network function nodes to the core network.

10. A device for wireless communication, comprising:
at least one hardware processor; and
at least one non-transitory memory storing instructions, which, when executed by the at least one hardware processor, cause the device to:
transmit a discovery message to a Network Repository Function (NRF) node,
wherein the discovery message comprises one or more query parameters to discover one or more network function nodes;
receive a discovery response from the NRF node,
wherein the discovery response comprises a search result in response to the one or more query parameters, the search result comprising information about the one or more network function nodes;
maintain a local storage storing a subset of the information carried in the search result;
determine, in response to the NRF node encountering an outage, information about a first network function node of the one or more network function nodes using the local storage; and
perform a communication with the first network function node while the NRF node being in the outage.

11. The device of claim 10, wherein the search result is associated with a validity period, and wherein the at least one hardware processor is configured to maintain of the local storage based on:
determining that the information about the one or more network function nodes in the search result has expired based on the validity period; and
removing the expired information about the one or more network function nodes from the local storage.

12. The device of claim 11, wherein the at least one hardware processor is configured to further maintain the local storage based on:
transmitting a request to the NRF node to obtain valid information about the one or more network function nodes; and
storing the valid information about the one or more network function nodes in the local storage.

13. The device of claim 10, wherein the at least one hardware processor is configured to further maintain the local storage based on:
periodically transmitting a request to the NRF node to obtain updated information about the one or more network function nodes;
storing the updated information about the one or more network function nodes.

14. The device of claim 13, wherein a periodicity for the periodically transmitting of the request is configurable.

15. The device of claim 10, wherein the device is implemented as a network function node.

16. The device of claim 10, wherein the device is implemented as a network server separate from network function nodes in a core network.

17. A non-transitory, computer-readable storage medium comprising instructions recorded thereon, wherein the instructions when executed by at least one processor of a system, cause the system to:
transmit a discovery message to a Network Repository Function (NRF) node,
wherein the discovery message comprises one or more query parameters to discover one or more network function nodes;
receive a discovery response from the NRF node,
wherein the discovery response comprises a search result in response to the one or more query parameters, the search result comprising information about the one or more network function nodes;
maintain a local storage storing a subset of the information carried in the search result;
determine, in response to the NRF node encountering an outage, information about a first network function node of the one or more network function nodes using the local storage; and
perform a communication with the first network function node while the NRF node being in the outage.

18. The non-transitory, computer-readable storage medium of claim 17, wherein the search result is associated with a validity period, and wherein the at least one processor is configured to maintain of the local storage based on:
determining that the information about the one or more network function nodes in the search result has expired based on the validity period; and
removing the expired information about the one or more network function nodes from the local storage.

19. The non-transitory, computer-readable storage medium of claim 18, wherein the at least one processor is configured to maintain of the local storage further based on:
transmitting a request to the NRF node to obtain valid information about the one or more network function nodes; and
storing the valid information about the one or more network function nodes in the local storage.

20. The non-transitory, computer-readable storage medium of claim 19, wherein the at least one processor is configured to maintain of the local storage based on:
periodically transmitting a request to the NRF node to obtain updated information about the one or more network function nodes;
storing the updated information about the one or more network function nodes.
